(19) United States
(12) Patent Application Publication
(10) Pub. No.: US 2010/0131726 A1
(43) Pub. Date: May 27, 2010

(54) METHODS, APPARATUSES, AND COMPUTER PROGRAM PRODUCTS FOR ENHANCING MEMORY ERASE FUNCTIONALITY

(75) Inventor: OLLI OLAVI LUUKKAINEN, Salo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/324,115

(22) Filed: Nov. 26, 2008

(51) Int. Cl. G06F 12/02

(52) U.S. Cl. 711/156; 711/E12.002

(57) ABSTRACT

A method, apparatus, and computer program product are provided for enhancing memory erase functionality. An apparatus may include a processor configured to initiate, at a slave device comprising a block-based mass memory, a memory management session with a host device in communication with the slave device such that the host device has ability to read from and write to the mass memory. The processor may be further configured to track changes made by the host device to memory allocation data stored on a memory block within the mass memory. The processor may additionally be configured to determine based at least in part upon the tracked changes whether the host device marked any memory blocks as free. The processor may be further configured to erase one or more memory blocks determined to be marked as free. Corresponding methods and computer program products are also provided.

### TECHNOLOGICAL FIELD

Embodiments of the present invention relate generally to computing technology and, more particularly, relate to methods, apparatuses, and computer program products for enhancing memory erase functionality.

### BACKGROUND

The modern computing era has brought about a tremendous expansion in use, power, capabilities, and portability of computing devices. Mobile computing devices, such as cellular phones, personal digital assistants, digital cameras, media players, and other portable electronic devices have evolved from luxury items to ubiquitous devices integrated into the everyday lives of individuals from all walks of life. Concurrent with the rise in use and power of mobile computing devices, personal computing devices, such as desktop and laptop computers, have continued to serve as integral computing platforms often used to access, manage, and exchange data with mobile computing devices.

Helping to fuel this expansion in computing device technology is an evolution in the capacity of memory in conjunction with a reduction in the price per unit of memory. Accordingly, computing devices and users and manufacturers of computing devices have access to higher capacity memory at a lower cost. This increased memory capacity and reduced memory cost is important, as users often utilize computing devices to store large files, such as media files, and often transfer files between their computing devices, often requiring management and rewriting of data stored on a memory.

One memory technology that has proven particularly useful is non-volatile block-based memory, such as flash memory. Flash memory has proven to be particularly useful, since as non-volatile memory, flash memory does not require any power to maintain data stored on the memory. Additionally, flash memory can be electrically erased and reprogrammed. Accordingly, flash memory has proven to be particularly useful for usage in mobile computing devices, where data is frequently overwritten and limiting power consumption is a concern. Additionally, the small size and large capacity of some flash memory devices, such as universal serial bus (USB) flash drives, facilitates the transfer of data between computing devices.

However, flash memory has some drawbacks. Although smaller subunits of a block of flash memory can be read and programmed, as a block-based memory, it can only be erased a block at a time. In this regard, a flash memory is divided into a plurality of units known as “blocks,” which have a defined size, often of several bytes. Further, before rewriting a byte or block of memory that has already been written to, the entire block must be erased so as to return the block to its initial state prior to performing a write operation. Erasing a block before overwriting the block has consequences in that blocks of mass memory have a finite lifespan in that a block can only be written to a finite number of times before it is no longer writeable. Further, the requirement to erase an entire block prior to rewriting a subunit within the block may result in a noticeable latency between a write request and the actual write operation. Additionally, this requirement may result in a significant amount of data transfer overhead over a memory bus, particularly if an erase operation is performed immediately prior to a write operation in response to a write request.

Accordingly, it would be advantageous to provide methods, apparatuses, and computer program products for enhancing memory erase functionality.

### BRIEF SUMMARY OF SOME EXAMPLES OF THE INVENTION

A method, apparatus, and computer program product are therefore provided for enhancing memory erase functionality. In this regard, embodiments of the invention provide methods, apparatuses, and computer program products for tracking changes made to memory allocation data of a mass memory embodied on a slave device by a host device engaged in a memory management session with the slave device. Tracking changes made to memory allocation data enables pre-erasing of blocks marked as free by the host device prior to overwriting of the freed blocks in at least some embodiments of the invention. Pre-erasing in at least some embodiments of the invention speeds up write performance since there is not a need to wait for erasure of the blocks to which data is being written before the data is actually written.

In a first exemplary embodiment, a method is provided, which may include initiating, at a slave device comprising a block-based mass memory, a memory management session with a host device in communication with the slave device such that the host device has ability to read from and write to the mass memory. The method may further include tracking changes made by the host device to memory allocation data stored on a memory block within the mass memory. The method may additionally include determining based at least in part upon the tracked changes whether the host device marked any memory blocks as free. The method may also include erasing one or more memory blocks determined to be marked as free.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction is for initiating, at a slave device comprising a block-based mass memory, a memory management session with a host device in communication with the slave device such that the host device has ability to read from and write to the mass memory. The second program instruction is for tracking changes made by the host device to memory allocation data stored on a memory block within the mass memory. The third program instruction is for determining based at least in part upon the tracked changes whether the host device marked any memory blocks as free. The fourth program instruction is for erasing one or more memory blocks determined to be marked as free.

In another exemplary embodiment, an apparatus is provided, which may include a processor configured to initiate, at a slave device comprising a block-based mass memory, a memory management session with a host device in communication with the slave device such that the host device has ability to read from and write to the mass memory. The processor may be further configured to track changes made by the host device to memory allocation data stored on a memory block within the mass memory. The processor may additionally be configured to determine based at least in part upon the tracked changes whether the host device marked any memory blocks as free. The processor may be further configured to erase one or more memory blocks determined to be marked as free.

In another exemplary embodiment, an apparatus is provided, which may include means for initiating, at a slave device comprising a block-based mass memory, a memory management session with a host device in communication with the slave device such that the host device has ability to read from and write to the mass memory. The apparatus may further include means for tracking changes made by the host device to memory allocation data stored on a memory block within the mass memory. The apparatus may additionally include means for determining based at least in part upon the tracked changes whether the host device marked any memory blocks as free. The apparatus may also include means for erasing one or more memory blocks determined to be marked as free.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for enhancing memory erase functionality according to an exemplary embodiment of the present invention;

FIG. 2 is a schematic block diagram of a mobile terminal according to an exemplary embodiment of the present invention; and

FIGS. 3-4 are flowcharts according to exemplary methods for enhancing memory erase functionality according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, a “block-based memory” refers to a non-volatile memory arranged into units known as “blocks.” These blocks are also sometimes referred to as “allocation units” or “clusters.” Each block within a block-based memory has a predefined size, (e.g., 512 bytes), which may be defined by a file system used to format the block-based memory. Each block is comprised of smaller subunits (e.g., a bit, byte, sector, page, and/or the like for example) that are individually readable and writable by a computing device controlling or otherwise having access to a block-based memory. However, block-based memory is only block erasable such that the smallest unit of a block-based memory that is erasable is a block rather than an individual byte or other subunit of a block. Further, once data has been written to a unit of a block-based memory (e.g., a bit, byte, sector, page, block, or other unit), the block containing the unit must be erased so as to return the block to its initial state prior to a write operation to overwrite the data or to otherwise write new data to the unit. An example embodiment of a block-based memory is flash memory. However, a block-based memory as used herein is not limited to embodiment as flash memory.

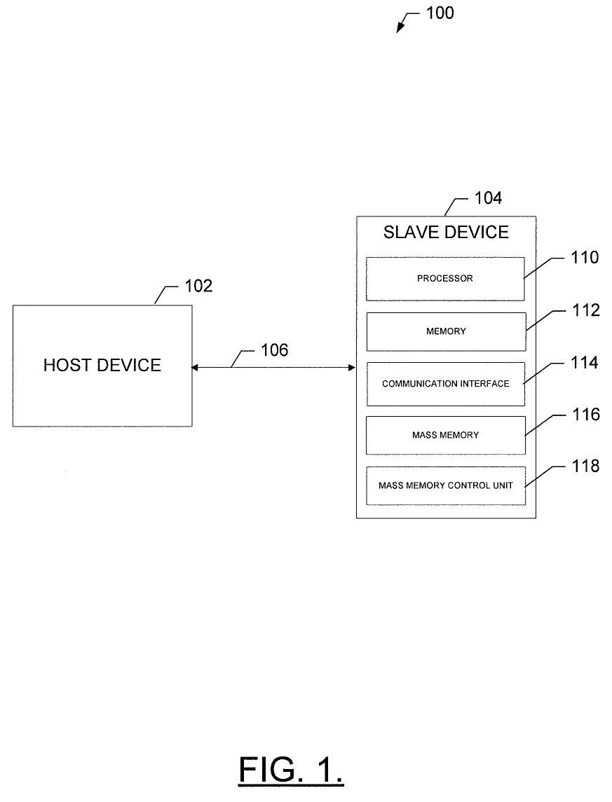

FIG. 1 illustrates a block diagram of a system 100 for enhancing memory erase functionality according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for enhancing memory erase functionality, numerous other configurations may also be used to implement embodiments of the present invention.

Referring now to FIG. 1, the system 100 includes a host device 102 and slave device 104 configured to communicate over a communications link 106. The host device may be embodied as any computing device, mobile or fixed, and in an exemplary embodiment is embodied as a personal computing device. The communications link 106 may comprise any wired communications link, wireless communications link, or some combination thereof over which data may be exchanged so as to allow the host device 102 to read and write a memory embodied on or connected to the slave device 104. Examples of wired communications link embodiments of the communications link 106 include, but are not limited to, a Universal Serial Bus (USB) cable, Firewire (Institute of Electrical and Electronics Engineers (IEEE) 1394) cable, parallel cable (IEEE 1284), serial cable (IEEE 1384), small computer system interface (SCSI), and/or the like. Examples of wireless communications link embodiments of the communications link 106 include, but are not limited to, a Bluetooth™ connection, wireless local area network (WLAN) connection, such as in accordance with one of the 802.11 standards, other radio frequency communications interface standards, infrared (IR), wireless USB, and/or the like. In an exemplary embodiment, the communications link 106 comprises a universal serial bus (USB) cable and/or a USB bus.

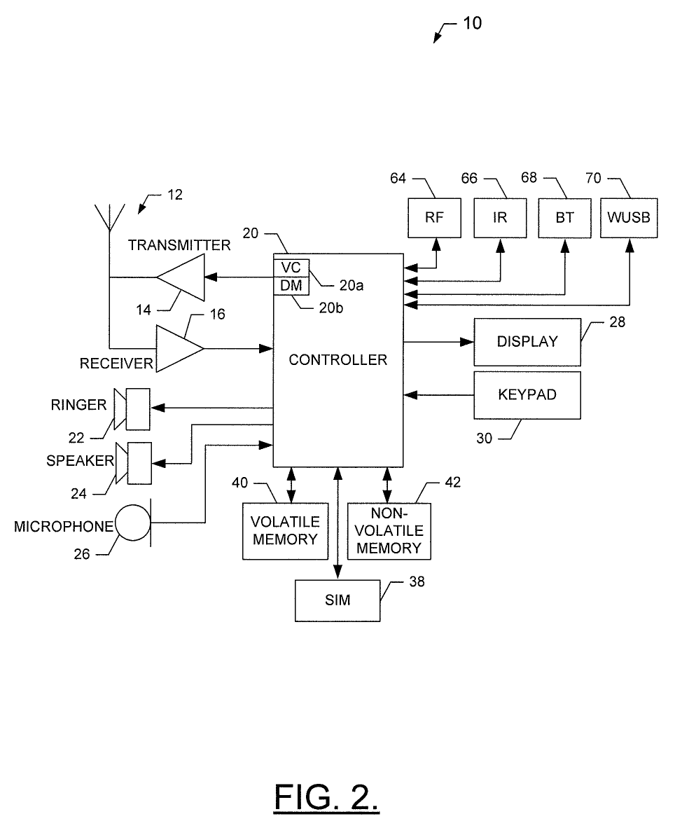

The slave device 104 may be embodied as any computing device comprising a block-based memory, including, for example, a mobile terminal, mobile computer, mobile phone, mobile communication device, game device, digital camera/camcorder, audio/video player, television device, radio receiver, digital video recorder, positioning device, digital media player (e.g., a mobile video player, MP3 player, and/or the like), a USB flash drive, any combination thereof, and/or the like. In an exemplary embodiment, the slave device 104 is embodied as a mobile terminal, such as that illustrated in FIG. 2. In this regard, FIG. 2 illustrates a block diagram of a mobile terminal 10 representative of one embodiment of a slave device 104 in accordance with embodiments of the present invention. It should be understood, however, that the mobile terminal illustrated and hereinafter described is merely illustrative of one type of slave device 104 that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. In an exemplary embodiment of the mobile terminal 10, the non-volatile memory 42 comprises a block-based memory, such as a flash memory. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, the slave device 104 is not limited to being embodied as a mobile terminal 10 and as previously described, may be embodied as any computing device comprising a block-based memory. In an exemplary embodiment, the slave device 104 is embodied as a USB mass storage device, which may comprise any of the aforementioned embodiments of the slave device 104 so long as the computing device embodying the slave device 104 is configured to communicate via a USB connection (e.g., the communications link 106) with a host device 102 to engage in a USB mass memory management session utilizing the USB mass storage device class protocol. Accordingly, in such an exemplary embodiment the host device 102 is likewise configured to engage in a USB mass memory management session and access a block-based memory (e.g., the mass memory 116) embodied on a slave device 104 using the USB mass storage device class protocol.

In an exemplary embodiment, the slave device 104 includes various means, such as a processor 110, memory 112, communication interface 114, mass memory 116, and mass memory control unit 118 for performing the various functions herein described. These means of the slave device 104 as described herein may be embodied as, for example, hardware elements (e.g., a suitably programmed processor, combinational logic circuit, and/or the like), computer code (e.g., software or firmware) embodied on a computer-readable medium (e.g. memory 112 or mass memory 116) that is executable by a suitably configured processing device (e.g., the processor 110), or some combination thereof. The processor 110 may, for example, be embodied as various means including a microprocessor, a coprocessor, a controller, or various other processing elements including integrated circuits such as, for example, an ASIC (application specific integrated circuit) or FPGA (field programmable gate array). In embodiments wherein the slave device 104 is embodied as a mobile terminal 10, the processor 110 may be embodied as or otherwise comprise the controller 20. In an exemplary embodiment, the processor 110 is configured to execute instructions stored in a memory (e.g., the memory 112 and/or mass memory 116) or otherwise accessible to the processor 110. Although illustrated in FIG. 1 as a single processor, in some embodiments the processor 110 comprises a plurality of processors. The plurality of processors may accordingly operate cooperatively to implement the functionality of the processor 110 as described herein.

The memory 112 may include, for example, volatile and/or non-volatile memory. In an exemplary embodiment, the memory 112 is configured to store information, data, applications, instructions, or the like for enabling the slave device 104 to carry out various functions in accordance with exemplary embodiments of the present invention. For example, the memory 112 may be configured to buffer input data for processing by the processor 110. Additionally or alternatively, the memory 112 may be configured to store instructions for execution by the processor 110. The memory 112 may store static and/or dynamic information. This stored information may be stored and/or used by the mass memory control unit 118 during the course of performing its functionalities.

The communication interface 114 may be embodied as any device or means embodied in hardware, software, firmware, or a combination thereof that is configured to receive and/or transmit data from/to a remote device, such as the host device 102 over the communications link 106. In one embodiment, the communication interface 114 is at least partially embodied as or otherwise controlled by the processor 110. The communication interface 114 may include, for example, an antenna, a transmitter, a receiver, a transceiver, bus, and/or supporting hardware or software for enabling communications with the host device 102. The communication interface 114 may be configured to receive and/or transmit data using any protocol that may be used for communications between the host device 102 and slave device 104. In this regard, the communication interface 114 is configured in at least some embodiments to support communications between the host device 102 and slave device 104 during a memory management session. In embodiments wherein the memory management session comprises a USB mass memory management session, the communication interface 114 is configured to facilitate communication between the host device 102 and slave device 104 using USB mass storage device class protocols. The communication interface 114 may additionally be in communication with the memory 112, mass memory 116, and/or mass memory control unit 118, such as via a bus.

The mass memory 116 comprises a block-based memory. In some embodiments, the mass memory may comprise the memory 112. The mass memory 116 is, in some embodiments, an integrated component of the slave device 104. In other embodiments, the mass memory device 116 is embodied as, for example, a flash memory card that may be connected to a port (e.g., a USB port) or inserted into a memory card receptacle of the slave device 104. One or more blocks of the mass memory 116 store memory allocation data for a file system that describes allocation of blocks within the mass memory 116. In this regard, each block of memory allocation data comprises a plurality of subunits (e.g., bytes, sectors, bits, and/or the like), each of which corresponds to a block of the mass memory 116. A value of the subunit denotes whether the corresponding block is free or allocated. For example, a free block may be denoted by a ‘0’ value, while an allocated block may be denoted by a ‘1’ value. The memory allocation data may, for example, comprise a file allocation table (FAT).

The mass memory control unit 118 may be embodied as various means, such as hardware, software, firmware, or some combination thereof and, in one embodiment, may be embodied as or otherwise controlled by the processor 110. In embodiments where the mass memory control unit 118 is embodied separately from the processor 110, the mass memory control unit 118 may be in communication with the processor 110. In some embodiments, the mass memory control unit 118 is physically embodied on the mass memory 116. In other embodiments, the mass memory control unit 118 is physically separated from the mass memory 116, but is in communication with the mass memory 116 so as to facilitate memory management. The mass memory control unit 118 may comprise, execute, or otherwise control file system software of the client device 104 for managing memory allocation in the mass memory 116. In at least one embodiment, the mass memory control unit 118 is configured to erase blocks of the mass memory 116 that have been freed. Freed blocks may be indicated in memory allocation data stored on one or more blocks of the mass memory 116. In some embodiments, the mass memory control unit 118 is configured to perform memory management services, such as wear leveling to balance out writes among blocks of the mass memory 116 so as not to prematurely exhaust the lifespan of a block through disproportionately writing to the block.

The mass memory control unit 118, in at least some embodiments, is configured to initiate a memory management session with the host device 102 such that the host device may read from and write to the mass memory 116. In this regard, the mass memory control unit 118 may be configured to initiate the memory management session automatically in response to connection of the host device 102 to the slave device 104 via the communications link 106. Additionally or alternatively, the mass memory control unit 118 may be configured to initiate the memory management session in response to receipt of a command or query from the host device 102 to initiate a memory management session. In at least some embodiments, the memory management session comprises a USB mass storage session. It will be appreciated, however, that USB mass storage session and USB mass storage device class communications protocols represent merely one standard memory management protocol that may benefit from embodiments of the present invention. Accordingly, embodiments of the present invention may have application to other memory management protocols and standards. Thus, where USB mass storage session, USB mass storage device, USB mass storage mode, USB mass storage device class communications protocols, and/or the like are used, it is merely for purposes of example.

In initiating a memory management session, the mass memory control unit 118 may be configured to set the slave device 104 file system that otherwise manages memory allocation within the mass memory 116 to USB mass storage mode such that only the host device 102 has write access to the file system's memory allocation data. In this regard, the mass memory control unit 118 may unmount or close the file system. Additionally or alternatively, the mass memory control unit 118 may be configured to set the file system to read-only mode.

During initiation of the memory management session, the host device 102 may mount the file system for the mass memory 116 based at least in part upon the memory allocation data stored on the mass memory 116, thus bypassing the file system of the slave device 104. The host device 102 may manipulate data stored on the mass memory 116 on a file or folder level, such as by deleting files or folders from, writing files or folders to the mass memory 116, and/or modifying files or folders stored on the mass memory 116. In doing so, the host device 102 may change the memory allocation data to indicate corresponding blocks of memory that are free or allocated.

The mass memory control unit 118 is configured to track changes made by the host device 102 to the memory allocation data. In this regard, the mass memory control unit 118 may be configured to copy at least a portion of the memory allocation data to another memory location prior to the host device 102 changing the memory allocation data. This copied at least a portion of the memory allocation data is referred to as the “initial state memory allocation data.” The memory location to which the initial state memory allocation data is copied may be another volatile or non-volatile memory, such as a cache or the memory 112, or to another block(s) of the mass memory 116. The mass memory control unit 118 may copy the initial state memory allocation data during initiation of the memory management session or following initiation of the memory management session, but prior to the host device 102 performing a write operation on the memory allocation data on the mass memory 116 to which the initial state memory allocation data corresponds.

In at least some embodiments, the mass memory control unit 118 is further configured to determine based at least in part upon the tracked changes whether the host device 102 has marked any blocks of the mass memory 116 as free. The mass memory control unit 118 may perform this determination immediately following the host device 102 writing to or otherwise changing the tracked memory allocation data and/or following conclusion of the memory management session. In an exemplary embodiment, the mass memory control unit 118 performs the determination by comparing a value of the memory allocation data on the mass memory 116 to the initial state memory allocation data copied to another memory location prior to the host device 102 changing the memory allocation data on the mass memory 116. Accordingly, by comparing the initial state memory allocation data to the memory allocation data on the mass memory 116, the mass memory control unit 118 is configured to determine whether any subunits of the memory allocation data (e.g., bits, bytes, sectors, and/or the like) have been changed by the host device 102 to indicate that a previously allocated block of the mass memory 116 has been freed.

The mass memory control unit 118 is further configured, in at least some embodiments, to erase one or more memory blocks of the mass memory 116 determined to have been marked as free by the host device 102. In this regard, each subunit of the memory allocation data corresponds to a block of the mass memory 116. Accordingly, the mass memory control unit 118 may be configured to erase a block of the mass memory 116 corresponding to a subunit of the memory allocation data that has been changed by the host device 102 to indicate that the block of the mass memory 116 corresponding to that subunit has been freed. In an exemplary embodiment, the mass memory control unit 118 is configured to erase a block of the mass memory 116 by restoring the block to an initial state. In one embodiment, the mass memory control unit 118 may be configured to erase a block only upon conclusion of the memory management session so that all freed blocks may be erased at the same time. In some embodiments, the mass memory control unit 118 is configured to erase a block upon determination that the block has been marked as free and prior to conclusion of the memory management session.

The mass memory control unit 118 may be further configured to conclude a memory management session. The mass memory control unit 118 may be configured to conclude the memory management session following receipt of a command to conclude an active memory management session from the host device 102, following receipt of an indication of conclusion of an active memory management session from the host device 102, and/or automatically upon disconnection of the communications link 106 between the host device 102 and slave device 104. The mass memory control unit 118 may, upon conclusion of the memory management session, remount the file system of the slave device 104.

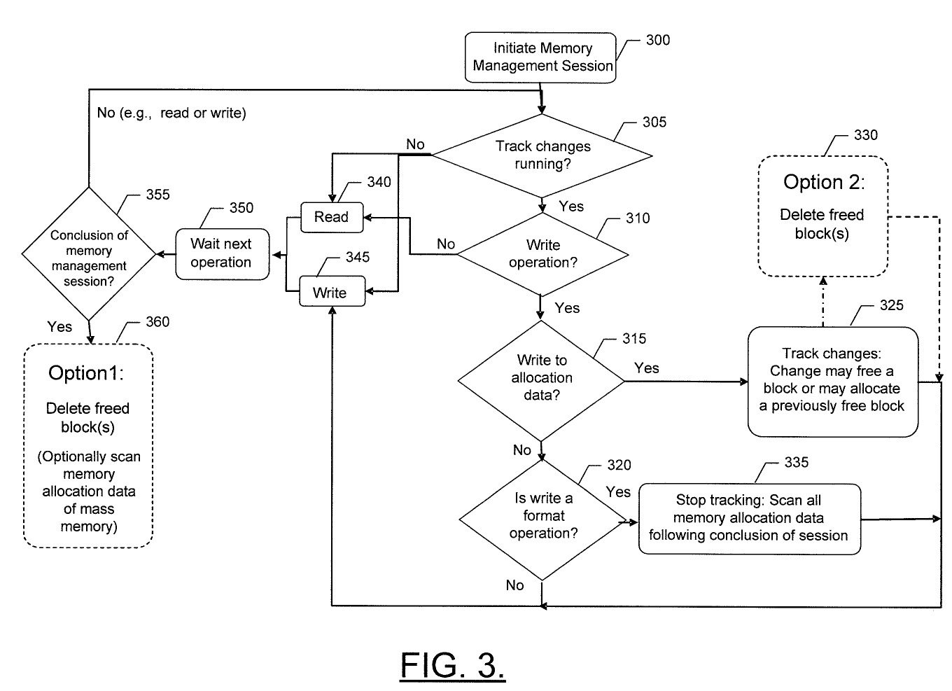

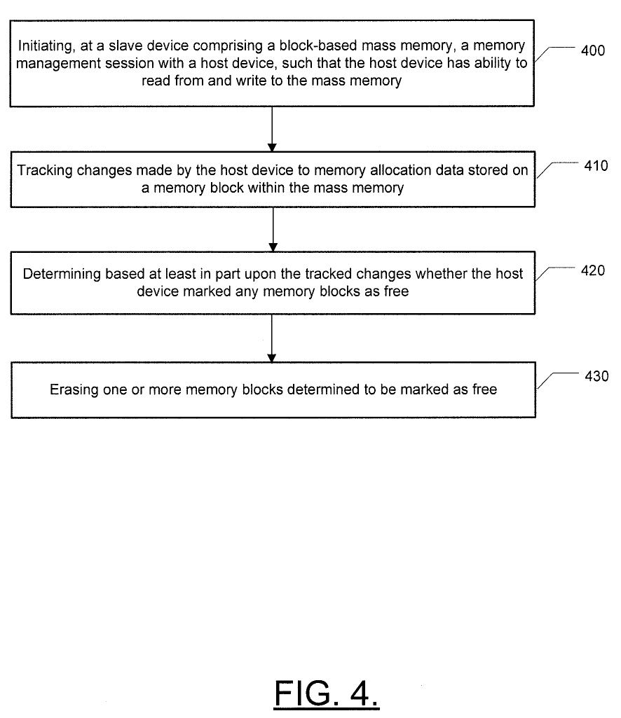

FIGS. 3-4 are flowcharts of systems, methods, and computer program products according to exemplary embodiments of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for enhancing memory erase functionality according to an exemplary embodiment of the present invention is illustrated in FIG. 3. The method may include the mass memory control unit 118 initiating a memory management session between the host device 102 and slave device 104, at operation 300. The mass memory control unit 118 may then determine whether track changes is running such that the memory control unit 118 can determine whether the host device 102 has marked any blocks of the mass memory 116 as free, at operation 305. If track changes is not running, such as due to detection of a format operation performed by the host device 102 (see, e.g., operation 320), the mass memory control unit 118 may stand by while the host device 102 reads from (operation 340) or writes to (operation 345) the mass memory 116 without tracking any changes made to the memory allocation data of the mass memory 116 by the host device 102.

If, on the other hand, the mass memory control unit 118 determines at operation 305 that track changes is running, the mass memory control unit 118 may determine when the host device 102 accesses the mass memory 116 whether the host device 102 has performed a write operation and written to the mass memory at operation 310. If, the access was not a write operation, then the host device 102 may perform a read operation and read from the mass memory 116, at operation 340, and the mass memory control unit 118 does not need to determine the access location of the read operation because the host device 102 is not changing any data stored in the mass memory 116. If the access was a write operation, then the mass memory control unit 118 may determine whether the write operation is a write to the memory allocation data, at operation 315. If the write operation is a write to memory allocation data of the mass memory 116, the mass memory control unit 118 may track changes so that the mass memory control unit 118 may determine whether the write frees a block or allocates a previously free block, at operation 325. In this regard, the mass memory control unit 118 may compare a portion of the memory allocation data following the write operation to corresponding initial state memory allocation data, which may have been copied to another memory or another block of the mass memory 116 prior to the write operation. In some embodiments, the mass memory control unit 318 may delete freed blocks prior to conclusion of the memory management session, at operation 330.

If, at operation 315, the mass memory control unit 118 determines that the write operation is not a write to the memory allocation data, the mass memory control unit 118 may determine whether the write operation indicates a format operation such that the host device 102 is formatting or reformatting at least a portion of the mass memory 116, at operation 320. The mass memory control unit 118 may determine whether the write operation is a format operation, for example, if some critical metadata of the memory allocation data is updated (e.g. if the memory allocation data is a FAT and the partition boot sector is over-written). If the write operation is a format operation, the mass memory control unit 118 may, at operation 335, stop tracking changes made to the memory allocation data by the host device 102 and scan all memory allocation data following conclusion of the memory management session such that the mass memory control unit 118 can take action to free blocks of the newly (re)formatted mass memory 116 as necessary.

If, at operation 320, the mass memory control unit 118 determines that the write operation is not a format operation, then the mass memory control unit 118 may standby while the host device writes to the mass memory 116 at operation 345, as the write operation is not one that requires tracking (e.g., a write to memory allocation data) or to stop tracking (e.g., a format operation). Following each read operation (operation 340) and write operation (operation 345) by the host device 102, the mass memory control unit 118 may wait for the host device 102 to perform a next operation, at operation 350. When the host device performs the next operation, the mass memory control unit 118 may determine whether the operation indicates conclusion of the memory management session, at operation 355. If the operation does not indicate conclusion of the memory management session, then the method returns to operation 305. If, however, the operation does indicate conclusion of the memory management session, the mass memory control unit 118 may, at operation 360, delete blocks of the mass memory 116 determined to be freed by the host device 102 during the memory management session in embodiments wherein the mass memory control unit 118 is configured to delete freed blocks following conclusion of the memory management session. The mass memory control unit 118 may additionally or alternatively scan the memory allocation data of the mass memory 116 to determine blocks of the mass memory 116 freed by the host device 102, such as following a format operation, at operation 360.

FIG. 4 illustrates an exemplary method for enhancing memory erase functionality according to an exemplary embodiment of the present invention. The method includes the mass memory control unit 118 initiating a memory management session with the host device 102 such that the host device 102 has the ability to read from and write to the mass memory, at operation 400. Operation 410 comprises the mass memory control unit 118 tracking changes made by the host device 102 to memory allocation data stored on a memory block within the mass memory 116. The memory allocation data describes an allocation status of one or more memory blocks within the mass memory 116. The mass memory control unit 118 determines based at least in part upon the tracked changes whether the host device 102 marked any memory blocks as free, at operation 420. Operation 430 comprises the mass memory control unit 118 erasing one or more memory blocks of the mass memory 116 determined to be marked as free.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, at least some embodiments of the invention provide several advantages. Embodiments of the invention provide methods, apparatuses, and computer program products for tracking changes made to memory allocation data of a mass memory embodied on a slave device by a host device engaged in a memory management session with the slave device. Tracking changes made to memory allocation data enables pre-erasing of blocks marked as free by the host device prior to overwriting of the freed blocks in at least some embodiments of the invention. Pre-erasing in at least some embodiments of the invention speeds up write performance since there is not a need to wait for erasure of the blocks to which data is being written before the data is actually written.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
initiating, at a slave device comprising a block-based mass memory, a memory management session with a host device in communication with the slave device such that the host device has ability to read from and write to the mass memory;
tracking changes made by the host device to memory allocation data stored on a memory block within the mass memory, wherein the memory allocation data describes an allocation status of one or more memory blocks within the mass memory;
determining based at least in part upon the tracked changes whether the host device marked any memory blocks as free; and
erasing one or more memory blocks determined to be marked as free.

2. A method according to claim 1, wherein the slave device comprises a universal serial bus mass storage device and wherein the memory management session comprises a universal serial bus mass memory management session.

3. A method according to claim 1, wherein the mass memory comprises a flash memory.

4. A method according to claim 1, wherein determining whether the host device marked any memory blocks as free comprises comparing a value of the memory allocation data following a change made by the host device to a value of the memory allocation data prior to the change made by the host device.

5. A method according to claim 4, further comprising:
copying initial state memory allocation data to a second memory prior to the host device making a change to the memory allocation data stored; and
wherein determining whether the host device marked any memory blocks as free comprises comparing a value of the memory allocation data following a change made by the host device to a value of the initial state memory allocation data.

6. A method according to claim 1, wherein erasing one or more memory blocks determined to be marked as free comprises erasing one or more memory blocks determined to be marked as free following conclusion of the memory management session.

7. A method according to claim 1, wherein erasing one or more memory blocks determined to be marked as free comprises erasing one or more memory blocks determined to be marked as free prior to conclusion of the memory management session.

8. A computer program product comprising at least one computer-readable storage medium having computer-readable program instructions stored therein, the computer-readable program instructions comprising:
a program instruction for initiating, at a slave device comprising a block-based mass memory, a memory management session with a host device in communication with the slave device such that the host device has ability to read from and write to the mass memory;
a program instruction for tracking changes made by the host device to memory allocation data stored on a memory block within the mass memory, wherein the memory allocation data describes an allocation status of one or more memory blocks within the mass memory;
a program instruction for determining based at least in part upon the tracked changes whether the host device marked any memory blocks as free; and
a program instruction for erasing one or more memory blocks determined to be marked as free.

9. A computer program product according to claim 8, wherein the slave device comprises a universal serial bus mass storage device and wherein the memory management session comprises a universal serial bus mass memory management session.

10. A computer program product according to claim 8, wherein the mass memory comprises a flash memory.

11. A computer program product according to claim 8, wherein the program instruction for determining whether the host device marked any memory blocks as free comprises instructions for comparing a value of the memory allocation data following a change made by the host device to a value of the memory allocation data prior to the change made by the host device.

12. A computer program product according to claim 11, further comprising:
a program instruction for copying initial state memory allocation data to a second memory prior to the host device making a change to the memory allocation data stored; and
wherein the program instruction for determining whether the host device marked any memory blocks as free comprises instructions for comparing a value of the memory allocation data following a change made by the host device to a value of the initial state memory allocation data.

13. A computer program product according to claim 8, wherein the program instruction for erasing one or more memory blocks determined to be marked as free comprises instructions for erasing one or more memory blocks determined to be marked as free following conclusion of the memory management session.

14. A computer program product according to claim 8, wherein the program instruction for erasing one or more memory blocks determined to be marked as free comprises instructions for erasing one or more memory blocks determined to be marked as free prior to conclusion of the memory management session.

15. An apparatus comprising a processor configured to:
initiate, at a slave device comprising a block-based mass memory, a memory management session with a host device in communication with the slave device such that the host device has ability to read from and write to the mass memory;
track changes made by the host device to memory allocation data stored on a memory block within the mass memory, wherein the memory allocation data describes an allocation status of one or more memory blocks within the mass memory;
determine based at least in part upon the tracked changes whether the host device marked any memory blocks as free; and
erase one or more memory blocks determined to be marked as free.

16. An apparatus according to claim 15, wherein the slave device comprises a universal serial bus mass storage device and wherein the memory management session comprises a universal serial bus mass memory management session.

17. An apparatus according to claim 15, wherein the mass memory comprises a flash memory.

18. An apparatus according to claim 15, wherein the processor is configured to determine whether the host device marked any memory blocks as free by comparing a value of the memory allocation data following a change made by the host device to a value of the memory allocation data prior to the change made by the host device.

19. An apparatus according to claim 18, wherein the processor is further configured to:
copy initial state memory allocation data to a second memory prior to the host device making a change to the memory allocation data stored; and
wherein the processor is configured to determine whether the host device marked any memory blocks as free by comparing a value of the memory allocation data following a change made by the host device to a value of the initial state memory allocation data.

20. An apparatus according to claim 15, wherein the processor is configured to erase one or more memory blocks determined to be marked as free by erasing one or more memory blocks determined to be marked as free following conclusion of the memory management session.

21. An apparatus according to claim 15, wherein the processor is configured to erase one or more memory blocks determined to be marked as free by erasing one or more memory blocks determined to be marked as free prior to conclusion of the memory management session.

22. An apparatus comprising:
means for initiating, at a slave device comprising a block-based mass memory, a memory management session with a host device in communication with the slave device such that the host device has ability to read from and write to the mass memory;
means for tracking changes made by the host device to memory allocation data stored on a memory block within the mass memory, wherein the memory allocation data describes an allocation status of one or more memory blocks within the mass memory;
means for determining based at least in part upon the tracked changes whether the host device marked any memory blocks as free; and
means for erasing one or more memory blocks determined to be marked as free.
